(19) United States
(12) Patent Application Publication
(10) Pub. No.: US 2026/0166687 A1
(43) Pub. Date: Jun. 18, 2026

(54) DEVICE FOR CONTROLLING A SUPPLY HANDLE

(71) Applicant: Carl Thomas Herakovich, Raleigh, NC (US)

(72) Inventor: Carl Thomas Herakovich, Raleigh, NC (US)

(21) Appl. No.: 19/368,257

(22) Filed: Oct. 24, 2025

Related U.S. Application Data
(63) Continuation-in-part of application No. 18/979,720, filed on Dec. 13, 2024, now abandoned.

(51) Int. Cl. B25B 13/48; F16K 31/60

(52) U.S. Cl. CPC B25B 13/481; F16K 31/60

(57) ABSTRACT

The invention is a device or tool designed to fit on a supply handle for turning the supply handle. It is especially useful to use the device at a distance or in a confined space and reduces risk of damage to the supply handle.

This application is a continuation in part of U.S. non-provisional application Ser. No. 18/979,720 filed Dec. 13, 2024, and is incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a device for turning a supply handle to an on, intermediate, or off position. In particular, it relates to a tool that can turn a supply handle on and off without breaking the supply handle or causing other damage especially when the supply handle is in a confined space.

### Description of Related Art

Supply handles are used in residential, commercial, and industrial applications to control the supply of liquids and gasses. A number of various handle configurations are used on these systems. For example, two and one wing handle configurations are frequently seen as shown in FIGS. 1 and 2. These supply handles can be positioned below ground surface level, in the ceiling, in the wall or other confined or distant space, and can also be difficult to turn, especially if they begin sticking. This makes them difficult to reach and difficult to control the supply by hand or with existing tools.

There are several various U-shaped devices designed to turn these types of handles. However, because they touch a handle in only limited select locations when wings are present, they can break the wings necessitating expensive repair. In addition, the U-shaped devices do not work on every supply handle shape, especially shapes that are a combination of round and irregular shaped portions, and the like. In addition, one reference discloses a tool at each end of a bar. One end is used to shut off a fire hydrant, and on the other end the height on a valve is controlled by raising or lowering the u-shaped end. It is designed to mate with a 1^{st} and 2^{nd} “clamping” means, not supply handles. Also, the devices require manual adjustment of height to prevent touching the surface the supply handle is on.

One example of a supply handle is the water shut off handle on a residential water supply pipe. These are usually used on PVC piping and are 1 or 2 wing supply handles (see examples in FIGS. 1 and 2).

### BRIEF SUMMARY OF THE INVENTION

The present invention relates to a device for turning a supply handle where the device simultaneously touches the top and sides of the handle thereby providing secure and precise engagement. This device provides control of the supply handle with a very low risk of breaking the supply handle while turning it, and works on 1 and 2 wing and other shape supply handles, unlike the U-shaped devices. It further removes the need to manually adjust the height of the device on the supply handle. Also, it facilitates engaging handles in locations that are difficult to access with hands or wrenches.

Accordingly, in one embodiment, there is a device for turning a supply handle positioned on a surface comprising:
a supply handle socket having a bottom cavity such that when the bottom cavity of the socket is placed on the supply handle the supply handle socket touches the top and sides of the supply handle.

### BRIEF DESCRIPTION OF THE DRAWINGS

FIG. 1 is a perspective view of a 2-wing water supply handle.

FIG. 2 is a perspective view of a 1-wing water supply handle.

FIG. 3 is a view of an embodiment of the device of the invention.

FIG. 4 is a bottom perspective of the device shown in FIG. 3.

FIG. 5 shows the device coming downward to cover a supply handle for turning.

FIG. 6 shows the device in place to turn the supply handle.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

Any publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “device” refers to a supply handle socket type tool which can be used, especially with an extender, to touch the supply handle as described below in a manner that the device can be used to turn the supply handle on or off without breaking the supply handle or requiring manual height adjustment. This is especially useful with some wing type handles which can easily be broken using U-shaped devices or devices requiring manual height adjustments. The device can be made of metal, composite, plastic, or the like as long as it is sturdy enough to turn the supply handle it is being used on. One of average skill in the art can determine optimum materials, thicknesses and the like. It can be molded, cast, machined, 3-D printed or the like into the desired shape for the desired supply handle. The device can also include an extender (removable or fixed) which allows the user of the device to turn a supply handle positioned in a confined space below ground, in a ceiling, in a wall, or distant space, and the like.

As used herein, the term “turning” refers to the user's ability to turn the supply handle to an open, intermediate, or closed position by turning the supply handle with the device.

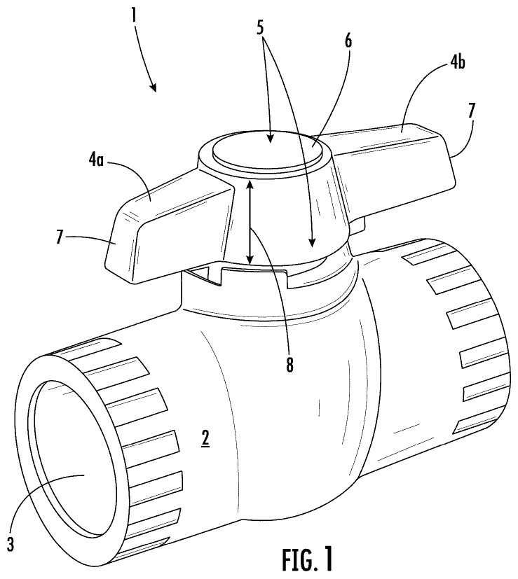

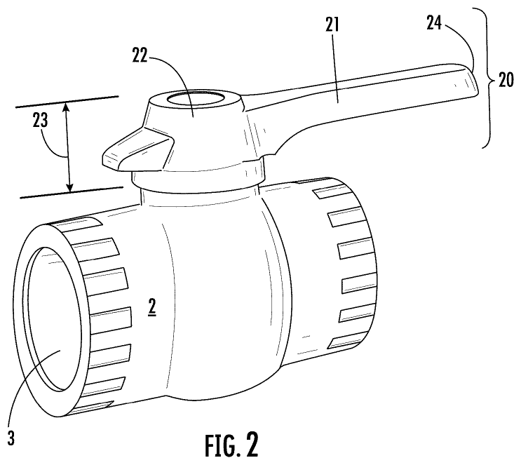

As used herein, the term “supply handle” refers to a handle which, by twisting or turning, controls a valve or the like which is used to position it to an on, off, or intermediate position. In the figures, there are examples of 1 and 2 wing supply handles used on a surface, namely a PVC pipe. Frequently, the handles control a ball and socket type control valve, but other uses are contemplated as well. The wing and some other supply handles have a long side, a short side, a top side and a height. The long sides and tops typically have a round portion as well as shown in FIGS. 1 and 2. The top of the round portion frequently is offset or raised for placing a logo or other information

As used herein, the term “supply handle socket” refers to the device for placing on a supply handle which allows a user to turn the supply handle. It has a bottom cavity such that when the bottom cavity of the supply handle socket is placed on the supply handle, it touches the top and sides of the supply handle simultaneously. While the socket need not touch the top and sides 100%, it needs to touch enough to be more than just minimal touching like U-shaped devices. It can touch 10%, 20%, 30% or more up to 100% as needed for each individual handle. It may not need to touch short sides.

As used herein the term “surface” refers to the area or upper boundary of what the supply handle is attached to. In one embodiment, a supply handle is attached to a pipe.

As used herein, the term “bottom cavity” refers to the open portion of the device which allows the device to be placed on the supply handle.

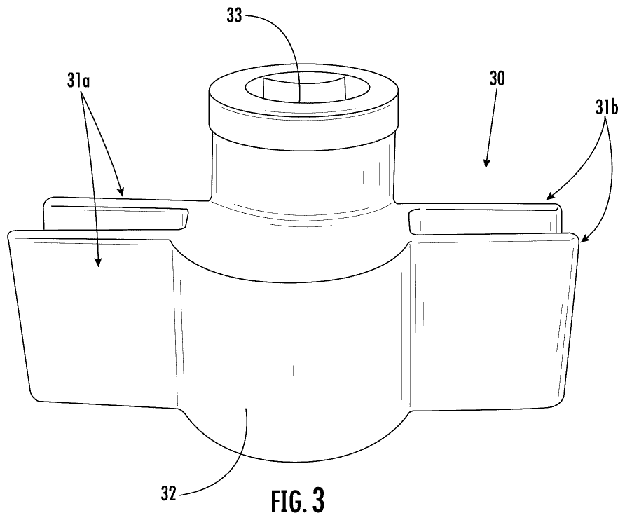

As used herein, the term “touches” refers to where the device comes in contact with a supply handle. The amount of minimum contact depends on the particular supply handle. The device at a minimum touches at least a portion of the top and sides of the supply handle simultaneously. Generally, the device contacts a long side and the top portion of the supply handle minus any recessed or elevated portions in the round part of the supply handle. The device could if desired touch the raised or recessed portion as well. Short sides of the supply handle need not be in contact with the device having one or two wings and thus a device as show in FIG. 3 can be used to turn the supply handle, though in one embodiment it touches the short sides and in other embodiments it doesn't. In one embodiment, it touches between 10% and 100% of each of the top sides of the supply handle. In another embodiment, it touches at least about 20%, 30%, 40%, 50%, 60%, 70%, 80%, 90%. By restricting the height, the device won't hit the surface the supply handle is on during use.

As used herein the term “socket” refers to an opening or hollow in the device that forms a holder for the supply handle allowing it to be turned.

As used herein, the term “extender” refers to something attached to the device either removable or non-removable which allows the device to be used at a distance. In one embodiment there is a receptor for removably attaching an extender. The opposite end has a grip portion for grabbing and turning the device. Typically, an extender is a pole, rod or the like that is grabbed by the user or connected to a wrench.

### Drawings

### Detailed Description

Now referring to the drawings, FIG. 1 is a perspective view of a supply handle, specifically a 2-wing supply handle 1 mounted on a PVC supply tube 2 having hollow portion 3 for passing fluid through the tube 2. The supply handle has first wing 4a and second wing 4b. The supply handle has round portion 5 which has a raised logo portion 6 on the top of the round portion 5. This type of supply handle has short ends 7. The supply handle has height 8.

FIG. 2 is a perspective view of a single wing supply handle 20. It has a single wing 21. It also has round portion 22. It has a height 23 and a single short end 24.

FIG. 3 is a view of an embodiment of the device of the invention. Device 30 has two device wings 31a and 31b. Further it has round portion 32 and on top of the round portion is extender female socket 33 where an extender bar or rod can be inserted. The spaces between the device wings are open and do not have a top. The underside, not shown, is open to allow the device to fit over a supply handle like the one shown in FIG. 1. It is clear that the device wings will touch the sides of the supply handle wings over their length and not just in specific points.

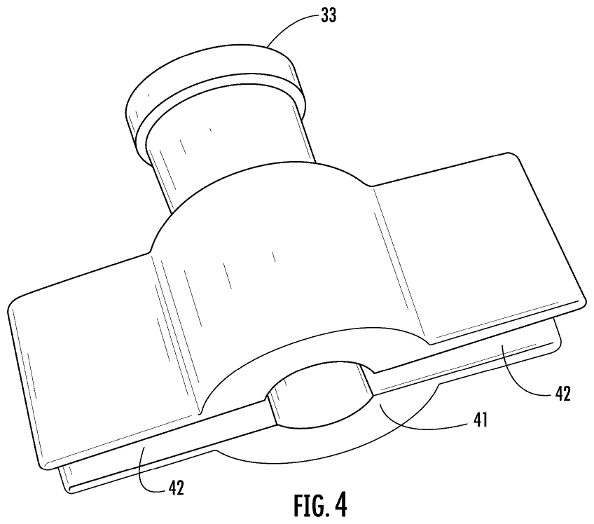

FIG. 4 is a side-bottom perspective of the device shown in FIG. 3. As can be seen in this view the entire bottom 41 is shown with the spaces between the device wings separated the open short ends 42 can be seen.

FIG. 5 shows device 30 being lowered 40 over 2 wing supply handle 41 which is attached to tube 42. This view shows the extender bar 43 either attached or by use of a female socket which allows the device 30 to be utilized at a distance, e.g. when it is in a confined space blow the surface.

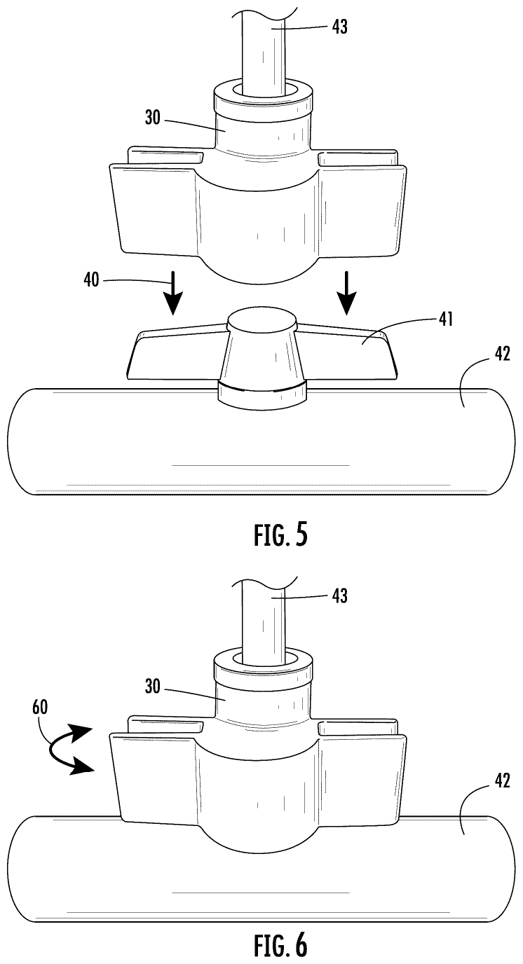

FIG. 6 shows device 30 placed over the supply handle 41 in preparation for turning 60 the supply handle underneath.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A device for turning a supply handle positioned on a surface comprising:
a supply handle socket having a bottom cavity such that when the bottom cavity of the socket is placed on the supply handle the supply handle socket touches the top and sides of the supply handle.

2. The device according to claim 1 wherein the device has a receptor for a removable extender.

3. The device according to claim 2 wherein an extender is non-removably attached to the device.

4. The device according to claim 1 wherein the device touches at least about 10% of each of the top and sides of the supply handle.

5. The device according to claim 1 wherein the device has a height which prevents the device from touching the surface while turning the handle.

6. The device according to claim 1 wherein the supply handle is a one or two wing handle.

7. The device according to claim 6 wherein the supply handle is on a PVC pipe.

8. The device according to claim 1 wherein when the supply handle has short sides and long sides, the device does not touch the short sides.

9. The device according to claim 1 wherein when the supply handle has a portion of the top which has a round shape top and where the device touches the top of the round shape is the only part of the top of the supply handle touched by the device.
